(19) United States
(12) Patent Application Publication
(10) Pub. No.: US 2008/0084065 A1
(43) Pub. Date: Apr. 10, 2008

(54) Exhaust pipe connecting device

(75) Inventor: Shoji Ogimura, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-Shi (JP)

(21) Appl. No.: 11/898,171

(22) Filed: Sep. 10, 2007

(30) Foreign Application Priority Data
Oct. 5, 2006 (JP) 2006-273697

(51) Int. Cl. F16L 19/00; F16L 21/00

(52) U.S. Cl. 285/369; 285/417

(57) ABSTRACT

An exhaust pipe connecting device includes a seal member, mounted on an end portion of a first exhaust pipe; a coupling member, mounted on an end portion of a second exhaust pipe; and a spring member, provided between the first exhaust pipe and the second exhaust pipe, that presses the seal member toward the coupling member. The first exhaust pipe and the second exhaust pipe are rotatably connected to each other while the coupling member contacts the seal member. The spring member has nonlinear spring characteristics such that a spring constant in a high load region in the operation range of the spring member is larger than a spring constant in a low load region in the operation range of the spring member.

### INCORPORATION BY REFERENCE

The disclosure of Japanese Patent Application No. 2006-273697 filed on Oct. 5, 2006, including the specification, drawings, and abstract is incorporated by reference in its entirety.

### BACKGROUND OF THE INVENTION

1. Field of the Invention

The present invention relates to an exhaust pipe connecting device, and more particularly, to a device for connecting exhaust pipes mounted on an exhaust passage extending from an internal combustion engine of a vehicle.

2. Description of the Related Art

In a vehicle, such as a car, equipped with an internal combustion engine (a power device), an exhaust pipe on the side of the engine severely rocks with respect to an exhaust pipe supported on the side of a vehicle body, due to a change in engine power or inertia when traveling on a rough road. For example, in a vehicle equipped with a transverse-mounted engine, severe rolling happens due to inertia of the engine. To restrict the vibration of the exhaust pipes disposed in the exhaust passage, an exhaust pipe connecting device is mounted to connect the exhaust pipe on the side of the engine and the exhaust pipe on the downstream side from the engine-side exhaust pipe (e.g., on the side of a muffler) so that the exhaust pipes can relatively rock.

Referring to Japanese Patent No. 2623876 (JP-B2-2623876), a conventional exhaust pipe connecting device is constituted such that a seal ring mounted on an end of a first exhaust pipe on the side of an exhaust manifold is contacts to a spherical-recess-shaped seal receiving part mounted on a second exhaust pipe, whereby the seal ring is pressed into the seal receiving part by an elastic member, such as a spring. A conventional exhaust pipe connecting device connects the first and second exhaust pipes so that they can relatively rock, thereby restricting the transfer of vibrations to the vehicle body in an idling state.

Furthermore, Japanese Patent Application Publication No. 5-231575 (JP-A-5-231575) describes interposing a vibration-damping member between the first exhaust pipe and the second exhaust pipe. Referring to Japanese Patent Application Publication No. 7-277284 (JP-A-7-277284), the conventional device of decreasing the natural frequency of a mount device, by using a nonlinear spring has been known, wherein the mount device mounts a catalyst that removes nitrogen oxide from an exhaust gas.

However, because a linear spring member having a uniform spring constant is used as the elastic member, the above conventional exhaust pipe connecting device has difficulty in simultaneously blocking the transfer of vibration to the vehicle body from the engine in the normal driving state, in which a relative rocking angle of the first and second exhaust pipes is small, and the restricting the excessive rocking of the exhaust pipes due to the excessive rolling of the engine. If a spring member having a relative small spring constant is used, typically laying emphasis on the vibration blocking effect, there may be a separation of the exhaust pipes in the high vibration load state, or flanges mounted on the first and second exhaust pipes may contact each other and generate noise. Also, because the conventional device should include the additional vibration damping member for achieving the vibration blocking effect, and the spring member having a spring constant large enough to satisfy the rock restriction effect, it has the problem of complicated structure and high costs.

In conventional mount devices for restricting the transfer of the vibration and the shock, which use the nonlinear spring as a part of the elastic supporting member, the elastic force of the nonlinear spring is generally not used for multiple functions by making the spring constant in the low load region and the spring constant in the high load region effectively different.

### SUMMARY OF THE INVENTION

The invention provides an exhaust pipe connecting device that has a simple constitution and prevents a separation of exhaust pipes in a high vibration load state and contact noise of flanges, i.e., capable of simultaneously achieving the vibration blocking and restriction to the excessive movement of the connecting portion of the exhaust pipes.

An exhaust pipe connecting device in accordance with a first aspect of the present invention includes a seal member, which is mounted on an end portion of a first exhaust pipe; a coupling member, which is mounted on an end portion of a second exhaust pipe; and a spring member, which is provided between the first exhaust pipe and the second exhaust pipe, that presses the seal member to the coupling member. The first exhaust pipe and the second exhaust pipe are relatively rotatably connected to each other while the coupling member contacts the seal member. The spring member has nonlinear spring characteristics such that a spring constant in a high load region in the operation range of the spring member is larger than a spring constant in a low load region in the operation range of the spring member.

According to the above constitution, by setting an adequate spring load when assembling the spring member (the minimum rock angle), the vibration between the first and second exhaust pipes may be blocked by an adequate spring constant of the spring member and the small spring constant in the low load region. Also, by the large spring constant of the spring member in the high load region, the substantial increase in the rock angle due to the high vibration load can be effectively restricted. Accordingly, it is not necessary to mount an additional vibration damping elements, and the separation of the connecting portion of the exhaust pipes or contact noise of flanges in the high vibration load state is prevented.

A second aspect of the invention directed to the exhaust pipe connecting device of the first aspect, wherein the spring member includes plural nonlinear springs. According to this constitution, simple springs may be used as the spring member such that a part of the nonlinear springs is compressed around the exhaust pipes and the remaining part of the nonlinear springs extends around the exhaust pipes. The spring is not restricted to any specific shape.

A third aspect of the invention is directed to the exhaust pipe connecting device of the second aspect, wherein the plural nonlinear springs are arranged in parallel with each other and are equidistant around the circumference of an end portion of the first exhaust pipe or an end portion of the second exhaust pipe. According to this constitution, the required vibration blocking effect and the excessive rock restriction effect can be simultaneously achieved, regardless of the rocking directions of the first and second exhaust pipes.

A fourth aspect of the invention is directed to the exhaust pipe connecting device of the second aspect, wherein each of the nonlinear springs is a metallic compression spring. According to this constitution, the spring member has high heat resistance adequate for the exhaust pipe connecting device in the high temperature circumstance, has high durability and reliability, and can be manufactured small and compactly. Also, the compression spring may also be a cylindrical-shaped compression coil spring having non-uniform pitch. However, the compression spring does not necessarily have a cylindrical shape, but may have a conical shape, a barrel shape, or a drum shape. The compression spring may be a combination spring or a plate spring (not a coil spring). Alternatively, the compression spring may be a spring member that is made partially or entirely of a viscoelastic material having heat resistance.

A fifth aspect of the invention is directed to the exhaust pipe connecting device of the fourth aspect, wherein one of the plural nonlinear springs compressed when the first exhaust pipe and the second exhaust pipe rock relatively from an initially connected state, operates in the range from the low load region to the high load region, and the other of the plural nonlinear springs, that extends when the first exhaust pipe and the second exhaust pipe rock relatively from the initially connected state, operates in only the low load region. According to this constitution, the transfer of the vibration to the vehicle body from the engine is effectively blocked, and at the same time the excessive vibration at the connecting portion of the exhaust pipes is effectively restricted.

A sixth aspect of the invention is directed to the exhaust pipe connecting device of the fourth aspect, wherein if a relative rock angle of the first exhaust pipe and the second exhaust pipe is a predetermined value or less, all of the plural nonlinear springs operate in the low load region in which the spring constant is small. Also, if the relative rock angle of the first exhaust pipe and the second exhaust pipe is more than the predetermined value, one of the plural nonlinear springs, that is compressed when the first exhaust pipe and the second exhaust pipe rock relatively from an initially connected state, may operate in the high load region in which the spring constant is large. According to this constitution, the transfer of the vibration to the vehicle body from the engine in the normal driving state is effectively blocked, and the excessive vibration at the connecting portion of the exhaust pipes due to the change in the engine power or the inertia when traveling on a rough road is effectively restricted.

A seventh aspect of the invention is directed to the exhaust pipe connecting device of the fourth aspect, wherein the compression spring is a cylindrical-shaped coil spring having a non-uniform pitch. In this case, the diameter of the exhaust pipe connecting device may be reduced and made more compact. Also, different spring constants may be easily set for the low load region and the high load region.

An eighth aspect of the invention is directed to the exhaust pipe connecting device of one of the above aspects, wherein the compression spring is a conical coil spring having a uniform pitch angle. According to this constitution, the region of the small spring constant is relatively expanded, the generation of the spring constant in the high load region is sufficiently secured, and the spring member becomes compact with much shorter length.

A ninth aspect of the invention is directed to the exhaust pipe connecting device of the second aspect, wherein each of the nonlinear springs is a plate spring. The nonlinear spring is not necessarily the only metallic plate spring, but may be combined with other types of springs. When the nonlinear spring is a plate spring, the relative movement of the first and second exhaust pipes may be restricted to a specific rocking direction, and accordingly components related thereto are removed, thereby manufacturing the simple and compact exhaust pipe connecting device.

A tenth aspect of the invention is directed to the exhaust pipe connecting device of the one of the above aspects, wherein the coil spring is a dual pitch spring. Also, each of the nonlinear springs may be a spring which has a non-uniform pitch such that the pitch of both end portions differs from the pitch of a middle portion, or as a spring in which the diameter of both end portions differs from the diameter of a middle portion.

An eleventh aspect of the invention is directed to the exhaust pipe connecting device of one of the above aspects, wherein the plate spring is a U-shaped plate spring. A contact portion of the coupling member with the U-shaped plate spring is formed in a curved shape which changes corresponding to deflection of the plate spring. Also, the plate spring may be configured such that the width or the thickness at the middle portion and both end portions in a lengthwise direction of a plate is set different. The plate spring may be provided with a notch formed at a predetermined position of a plate, or may includes plural overlapping plates. Alternatively, the plate spring may be configured such that a position of a contact portion with the coupling member can move.

A twelfth aspect of the invention is directed to the exhaust pipe connecting device of one of the above aspects, wherein the spring constant in the high load region is at least twice the spring constant in the low load region.

According to the above aspects, there is provided an exhaust pipe connecting device that prevents the separation at a connecting portion of exhaust pipes in a high vibration load state and contact noise of flanges without requiring the installation of an additional vibration damping element, i.e., the exhaust pipe connecting device is capable of simultaneously achieving the damping the vibration and restricting excessive movement of the connecting portion of the exhaust pipes.

### BRIEF DESCRIPTION OF THE DRAWINGS

The above and other objects and features of the present invention will become apparent from the following description of example embodiments, given in conjunction with the accompanying drawings, in which:

FIG. 1A is a longitudinal sectional view illustrating an exhaust pipe connecting device in accordance with a first embodiment of the present invention;

FIG. 1B is a rear view of essential components including a cross-section of the exhaust pipe seen from a downstream side of the exhaust pipe;

FIG. 2 is a sectional view illustrating a relative rotational state of a first exhaust pipe and a second exhaust pipe connected by the exhaust pipe connecting device in accordance with the first embodiment of the present invention;

FIG. 3 is a view illustrating a compression coil spring having non-uniform pitch which constitutes a spring member of the exhaust pipe connecting device in accordance with the first embodiment of the present invention;

FIG. 4 is a graph illustrating a relation between a load and a height of the compression coil spring having non-uniform pitch depicted in FIG. 3;

FIG. 5 is a graph illustrating a size of a gap between adjacent coils of the compression coil spring having nonuniform pitch depicted in FIG. 3;

FIG. 6 is a sectional view illustrating a nonlinear spring of an exhaust pipe connecting device in accordance with a second embodiment of the present invention;

FIG. 7 is a graph illustrating a relation between a load and a height of a conical coil spring depicted in FIG. 6;

FIG. 8 is a sectional view illustrating a modification of the nonlinear spring of the exhaust pipe connecting device in accordance with the second embodiment of the present invention; and

FIG. 9 is a longitudinal sectional view illustrating an exhaust pipe connecting device in accordance with a third embodiment of the present invention.

### DETAILED DESCRIPTION OF EXAMPLE EMBODIMENTS

Various embodiments of the invention will now be described in detail with reference to the accompanying drawings.

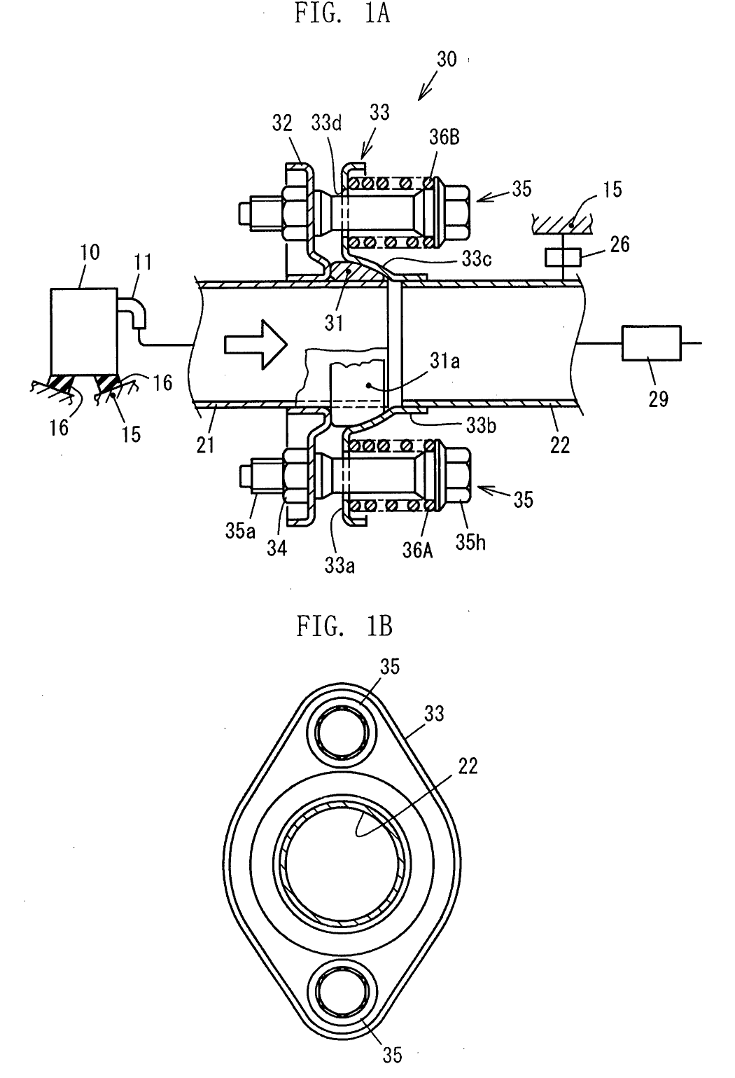

FIGS. 1A to 5 are views illustrating an exhaust pipe connecting device in accordance with a first embodiment of the present invention. FIG. 1A shows a cross-section of the connecting device and a longitudinal cross-section of exhaust pipes in a schematic view of an exhaust passage. As shown in FIG. 1A, an engine 10 (an internal combustion engine) is elastically mounted on a vehicle body-side member 15 (not shown in detail) by plural engine mounts 16. A first exhaust pipe 21 is connected to a downstream side of the exhaust manifold 11 of the engine 10, and a second exhaust pipe 22 is connected to the downstream side of the first exhaust pipe 21 by a connecting device 30. The engine 10 may be a transverse-mounted engine. The second exhaust pipe 22 is elastically supported on the vehicle body-side member 15 by using a support member 26 in a predetermined support manner, and a noise reduction device 29 is mounted on a downstream side of the second exhaust pipe 22. A catalyst device (not shown) is mounted on at least one of the first and second exhaust pipes 21 and 22 to purify the exhaust gas.

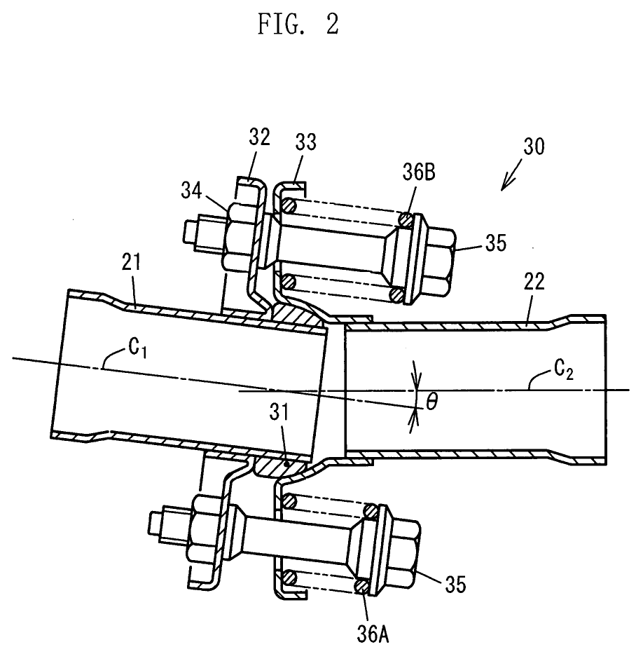

The connecting device 30 includes a seal bearing 31, a front flange 32, a flare flange 33, plural nuts 34, plural bolts 35, and plural set springs 36A and 36B, wherein the seal bearing 32 is a seal member having a spherical seal portion 31a surrounding a downstream-side end portion of the first exhaust pipe 21; the front flange 32 is integrally fixed to the first exhaust pipe 21 by welding and contacts an end of the seal bearing 31; the flare flange 33 is a coupling member fixed to an upstream-side end portion of the second exhaust pipe 22; plural nuts 34 are fixed to the front flange 32 and are formed with a female-screw hole (not shown in detail); plural bolts 35 are inserted through plural bolt-insertion holes 33d formed at the flare flange 33 and formed with a screw portion 35a screw-coupled to each of the nuts 34; and plural set springs 36A and 36B are mounted between bolt heads 35h of the bolts 35 and the flare flange 33 in a compressed preloaded condition with respective set forces (spring loads in the initially assembled state shown in FIG. 1A (a rock angle θ shown in FIG. 2 is zero), each of which is denoted by Fs in FIG. 4).

Although the seal bearing 31 is fixed to the downstream-side end of the first exhaust pipe 21, it may be detachably mounted on the first exhaust pipe 21 and pressed to contact the front flange 32 by the pressing force of the set springs 36A and 36B. The seal bearing 31 is made of a conventional material. The flare flange 33 includes a first end portion 33a that opposes the front flange 32, a second end portion 33b, which is fixed to the upstream-side end portion of the second exhaust pipe 22, and a concave spherical coupling portion 33c, which is formed between the first end portion 33a and the second end portion 33b and slidably coupled to the spherical seal portion 31a of the seal bearing 31.

The plural set springs 36A and 36B, which are axially mounted between the bolt heads 35h of the bolts 35 and the flare flange 33, press the flare flange 33 toward the front flange 32, and make the concave spherical coupling portion 33c of the flare flange 33 contact the spherical seal portion 31a of the seal bearing 31 with a predetermined contact pressure.

As shown in FIG. 2, the connecting device 30 connects the first exhaust pipe 21 and the second exhaust pipe 22 so that the first and second exhaust pipes 21 and 22 may rock relative to each other to thereby change an angle θ formed between a center axis line C₁ of the first exhaust pipe 21 and a center axis line C₂ of the second exhaust pipe 22 by the relative rocking between the first and second exhaust pipes 21 and 22 (hereinafter, which will be called a rocking angle θ).

According to the structures of the engine 10 and the exhaust passage, the connecting device 30 is mounted on a region in the exhaust passage where the amplitude of vibration of the exhaust pipes is the largest.

In the exhaust pipe connecting device 30 of this embodiment, the plural set springs 36A and 36B of the spring member have nonlinear load-deflection characteristics (spring characteristics) such that the spring constant in the high load region in the operation range of the spring is sufficiently larger (e.g., double or more) than the spring constant in the low load region in the operation range of the springs. In this embodiment, the plural set springs 36A and 36B disposed around the first and second exhaust pipes 21 and 22 are nonlinear springs, and may be embodied as metallic compression springs that are arranged parallel with each other and equidistant around the circumference of the exhaust pipes 21 and 22 (refer to FIG. 1B).

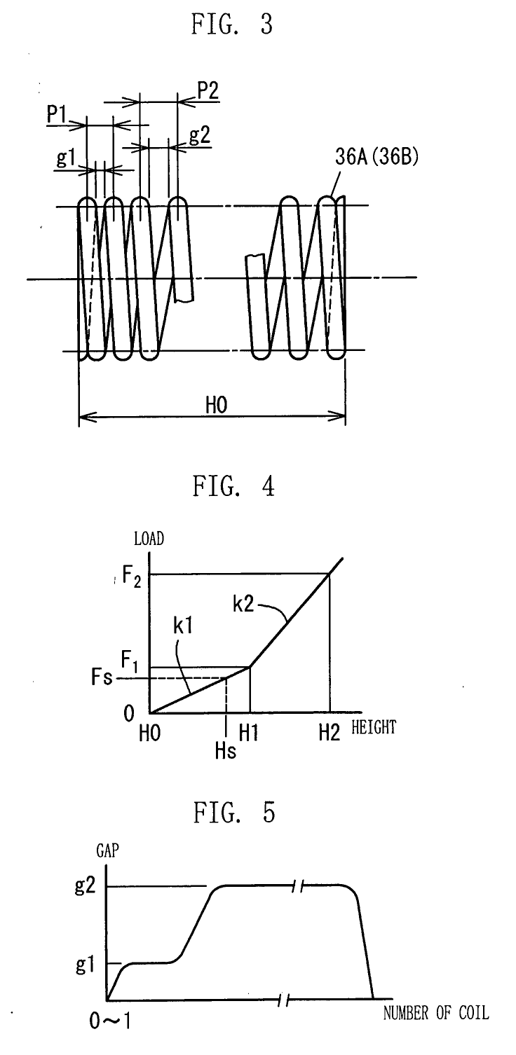

As shown in FIGS. 3 and 5, each of the set springs 36A and 36B is a cylindrical-shaped metallic compression coil spring in which pitches P1 and P2 or gaps g1 and g2 between coils are not uniform, e.g., the coil spring has a dual pitch configuration such that the pitch P1 of one end portion is different from the pitch P2 of the other end portion. Accordingly, as shown in FIG. 4, when the height of each of the set springs 36A and 36B is H0 (mm) corresponding to a free length, the load is 0 (N). When the height of the spring is Hs in the initially assembled state depicted in FIG. 1A (the rock angle is zero, the initial elastic state), the load is Fs. When the height of the spring is H1, which is an intermediate height positioned near the upper limit in the operation range of the spring capable of contributing to the vibration blocking from the spring height Hs, the load is F1. When the height of the spring is H2 in the maximum elastic state, the load is F2. Although, the set springs 36A and 36B do not necessarily have the dual pitch configuration, they may be configured as a conical nonlinear spring or a spring having non-uniform pitch such that the pitch of both end portions is different from the pitch of the middle portion. The set springs 36A and 36B may also be configured as a drum shaped or a barrel shaped nonlinear spring in which the diameter of the middle portion is different from the diameter of both end portions. Also, the spring member may be configured as a plate spring (which will be described later). If the set springs 36A and 36B have the dual pitch configuration, it is preferable to arrange the set springs 36A and 36B in the same direction (the end portions of the pitch P2 of the set springs 36A and 36B are directed together rightward or leftward in FIG. 1A). The set force of the set springs 36A and 36B is set so that the nonlinear spring 36A, operates in the range from the low load region to the high load region, wherein the nonlinear spring 36A is compressed when the first and second exhaust pipes 21 and 22 rock relatively as shown in FIG. 2 from the initially connected state shown in FIG. 1A. The nonlinear spring 36B operates in only the low load region, wherein the nonlinear spring 36B is extended when the first and second exhaust pipes 21 and 22 rock relatively as shown in FIG. 2 from the initially connected state from in FIG. 1A.

If the relative rocking angle θ of the first and second exhaust pipes 21 and 22 is a predetermined value or less, all the set springs 36A and 36B operate in the low load region in which the spring constant is small. On the other hand, if the relative rocking angle θ of the first and second exhaust pipes 21 and 22 is more than the predetermined value, the set spring 36A (compressed when the first and second exhaust pipes 21 and 22 rock relatively from the initially connected state) operates in the high load region in which the spring constant is large. Here, the set spring 36A compressed can be referred to any one of nonlinear springs that is compressed from the initially assembled state shown in FIG. 1A regardless of the mounting position of the set springs.

The detailed shape of the front flange 32 or the bolt 35 is depicted differently in part in FIGS. 1A and 2, however any shape can be applied. The predetermined value of the rock angle may be, for example, 3 degrees or less. At this time, when the increase in the rocking angle is practically restricted by the set springs 36A and 36B, the rocking angle θ is 6 degrees, for example. The front flange 32 and the flare flange 33 are depicted to have the outer circumference of an elliptical shape in FIG. 1B, however the outer circumference of the flanges 32 and 33 may be formed in a circular shape, or an arbitrary non-circular shape having plural protrusions formed in a radial direction. In FIG. 1A, it is depicted that the bolts 35 are screw-coupled to the front flange 32 and the bolt-insertion holes 33d are formed at the flare flange 33. However, the opposite arrangement, that the bolt-insertion holes are formed at the front flange 32 and the bolts are screw-coupled to the flare flange 33, is also possible.

Hereinafter, the operation of the exhaust pipe connecting device according to the present embodiment will be described. When a vehicle is subject to the change in the power of the engine 10 (e.g., starting, rapid accelerating, quick braking, or the like), or travels over a rough road, the first exhaust pipe 21 on the side of the engine 10 severely rocks with respect to the second exhaust pipe 22, due to the inertia of the engine 10 or the like. Also, when the engine 10 is in an idling operation state, vibration with a relatively large amplitude is apt to happen. Although the large vibration load is generated, the exhaust pipe connecting device 30 of the first embodiment of the invention effectively restricts the substantial increase in the rocking angle θ by the set spring 36A that is a spring member to be compressed and has the spring constant of the high load region. Accordingly, the spherical seal portion 31a of the seal bearing 31 securely contacts all around the concave spherical coupling portion 33c of the flare flange 33, and the front flange 32 and the flare flange 33 do not interfere with each other at their outer circumferences. As a result, in the high vibration load state, separation at the connecting portion of the exhaust pipes or contact noise of the flanges is prevented.

Moreover, in the normal driving state, with the exception of the aforesaid driving state by adequately setting the spring load (set force) Fs when assembling the spring member, the vibration of the first and second exhaust pipes 21 and 22 is effectively blocked by the relatively low spring load, which is about the intermediate load F1 or less (which is slightly larger than the set force Fs of the set springs 36A and 36B), and the small spring constant in the low load region. Accordingly, it is not necessary to mount an additional vibration damping element, and the vibration blocking effect may be achieved with a simple constitution.

In this embodiment, because the plural set springs 36A and 36B are mounted around the exhaust pipes 21 and 22, a part of the plural (two or more, or three) nonlinear springs disposed around the exhaust pipes is compressed, and the remaining part of the nonlinear springs is extended. Accordingly, the spring member may be configured as a simple nonlinear compression coil spring, such as the set springs 36A and 36B that are compressed and extended. The set springs 36A and 36B may be formed in a cylindrical shape so as to minimize the diameter of the spring member and make the exhaust pipe connecting device 30 compactly. Also, the set springs 36A and 36B may be configured as a dual pitch spring so as to easily set the spring constants k1 and k2, which are different in two regions divided by the intermediate spring height H1, i.e., the low load region (the region from the spring height H0 to the spring height H1) and the high load region (the region from more than the spring height H1 to the spring height H2), as shown in FIG. 4.

Because the plural set springs 36A and 36B are arranged in parallel with each other and equidistant around the circumference of the exhaust pipes 21 and 22, the required vibration blocking effect and the excessive rocking restriction effect can be simultaneously achieved, regardless of the rocking directions of the first and second exhaust pipes 21 and 22. Because the nonlinear set springs 36A and 36B are configured as a metallic compression spring, the set springs 36A and 36B have high heat resistance adequate for the exhaust pipe connecting device 30 in the high temperature circumstance, have high durability and reliability, and can be manufactured small (short) and compactly.

In this embodiment, the set spring 36A operates in the range from the low load region to the high load region, wherein the set spring 36A is compressed when the first and second exhaust pipes 21 and 22 rock relatively from the initially connected state, and the set spring 36B operates in only the low load region, wherein the set spring 36B is extended when the first and second exhaust pipes 21 and 22 rock relatively from the initially state. Accordingly, the transfer of the vibration to the vehicle body-side member 15 from the engine 10 is effectively blocked, and at the same time the excessive vibration at the connecting portion of the exhaust pipes 21 and 22 is effectively restricted. If the relative rocking angle θ of the first and second exhaust pipes 21 and 22 is the predetermined value or less, all the set springs 36A and 36B operate in the low load region in which the spring constant is small. If the relative rocking angle θ of the first and second exhaust pipes 21 and 22 is more than the predetermined value, the set spring 36A to be compressed operates in the high load region in which the spring constant is large. Accordingly, when the rocking angle θ is the predetermined value or less, the transfer of the vibration to the vehicle body-side member 15 from the engine 10 in the normal driving state is effectively blocked, and the excessive vibration at the connecting portion of the exhaust pipes due to the change in the engine power or the inertia is effectively restricted.

As described above, according to the present invention, there is provided the exhaust pipe connecting device that prevents the a separation at the connecting portion of exhaust pipes in the high vibration load state and contact noise of the flanges without the necessity of installing an additional vibration damping element, i.e., the exhaust pipe connecting device simultaneously blocks vibration and restricts excessive movement of the connecting portion of the exhaust pipes. In the above description of this embodiment, it has been explained that the set springs 36A and 36B as the spring member are configured as a cylindrical-shaped dual pitch spring, however this is not restricted thereto. In other words, the nonlinear compression spring used in the present invention is preferably a cylindrical-shaped compression coil spring having the non-uniform pitch, however the nonlinear compression spring does not necessarily have a cylindrical shape, but may have a conical shape, a barrel shape, or a drum shape. The spring member may be configured as a combination spring comprising plural springs. Also, the spring member may be configured as a plate spring (not a coil spring). If the spring member is configured as a conical coil spring, the length of the spring member may be reduced made more compact. If the spring member is configured as a plate spring, the relative movement of the first and second exhaust pipes may be restricted to a specific rotational direction. The spring member is not necessarily made of a metal material, and may be configured as a spring member which is made partially or entirely of a heat-resistant viscoelastic material.

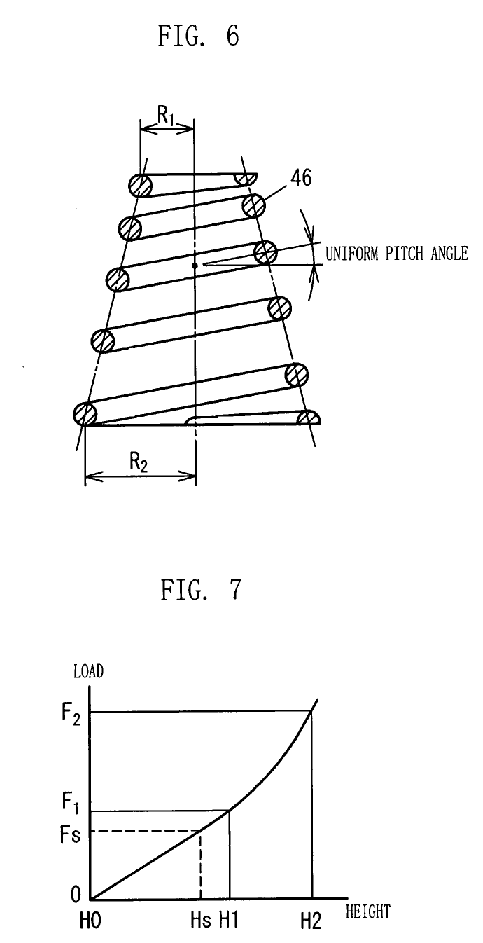

FIGS. 6 and 7 are views illustrating an exhaust pipe connecting device according to a second embodiment of the present invention. The same component as those of the first embodiment or the components corresponding to those of the first embodiment will be designated by like reference numerals as FIGS. 1A to 5, and the difference from the first embodiment will be described.

When compared to the first embodiment, the exhaust pipe connecting device 30 of this embodiment has features that there is room in the mounting space in a diameter direction. Conical coil springs 46 (hereinafter, which will be called set springs 46) having respectively a uniform pitch angle are used are used instead of the cylindrical-shaped dual pitched set springs 36A and 36B. For example, each of the set springs 46 is assembled such that its large-diameter end portion contacts the front flange 32 and its small-diameter end portion is coupled to the bolt head 35h of the bolt 35. In this case, each of the plural set springs 46 is configured to have nonlinear load-deflection characteristics such that the spring constant in the high load region (the region from more than the spring height H1 to the spring height H2 in FIG. 7) is sufficiently larger (e.g., double or more) than the spring constant in the low load region (the region from the spring height H0 to the spring height H1 in FIG. 7). The above constitution achieves the same effect as the first embodiment.

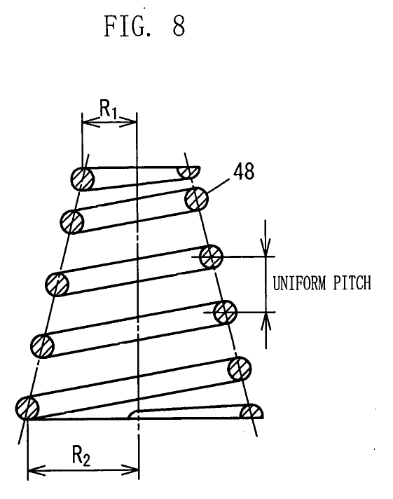

Because the pitch angle of the set springs 46 is uniform, the range of the low load region having the small spring constant is sufficiently secured, the initial elastic force of the set springs 46 may be set so that the contact pressure between the spherical seal portion 31a of the seal bearing 31 and the concave spherical coupling portion 33c of the flare flange 33 exceeds a predetermined value, and the spring load when restricting the rock in the high load region can be set to be larger (e.g., three times or more) than the set force. When intending to expand the nonlinear region, in which the spring constant begins changing, with respect to the linear region having the small spring constant in the load-deflection characteristics, conical coil springs 48 having a uniform pitch as shown in FIG. 8 may be used instead of the set springs 46.

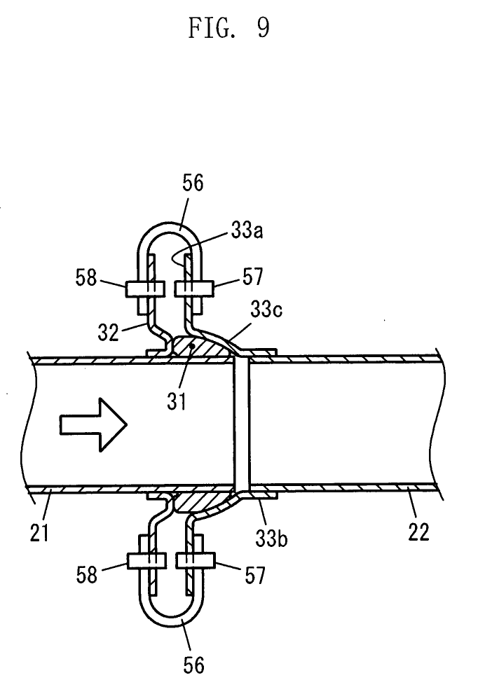

FIG. 9 is a longitudinal sectional view illustrating exhaust pipes and an exhaust pipe connecting device in accordance with a third embodiment of the present invention. The same components as those of the first embodiment or the components corresponding to those of the first embodiment will be designated by the like reference numerals as FIGS. 1A to 5, and the difference from the first embodiment will be described.

Instead of the set springs 36A and 36B, U-shaped plate springs 56 are used in this embodiment. Each plate spring 56 is mounted over the front flange 32 and the flare flange 33 to press the flanges 32 and 33 toward each other. The plate springs 56 may be fixed to the front flange 32 and the flare flange 33 by coupling concave and convex portions (not shown) of fixing plates 57 and 58 and the flanges 32 and 33, or by inserting fixing pins 57 and 58 through the flanges 32 and 33. The outermost circumferences of the front flange 32 and the flare flange 33 are not bent in the axial direction of the exhaust pipe as the first embodiment, but are formed in a flat shape. As needed, the contact portions of the flanges with the plate springs 56 may be formed in a curved shape which changes corresponding to the deflection of the plate springs 56.

When the first and second exhaust pipes 21 and 22 rock relatively, the plate springs 56 are divided into a compressed side of which both ends fixed to the flanges 32 and 33 approach each other, and an extended side of which both ends get away from each other. Such plate springs 56 function substantially identically to the nonlinear springs that are compressed and extended. Each of the plate springs 56 deflects to be compressed or extended when the first and second exhaust pipes 21 and 22 rock relatively. In order to acquire approximately the same spring characteristics the springs of the first embodiment, the plate springs 56 may be configured such that the width or the thickness at the middle portion and both end portions in the lengthwise direction of the plate is set different, or a notch having an appropriate shape is formed at the plate. Each of the plate springs 56 may be configured as plural overlapping plates. The plate spring-mounted surfaces of the flanges 32 and 33 may be curved in the deflection direction of the plate spring that is compressed so that the position of the contact portions of the flanges 32 and 33 with the plate springs 56 moves in accordance with the force of the plate springs 56 (the contact regions in which the deflection is restricted increase, and the deflectable length of the plate spring is shortened). In this case, each of the plural set springs (the spring member) configured as the plate springs 56 has nonlinear load-deflection characteristics such that the spring constant in the high load region is larger than the spring constant in the low load region in the operation range of the plural set springs configured as the plate springs 56. Accordingly, the above constitution can achieve the same effect as the first embodiment.

This embodiment restricts the relative movement of the first and second exhaust pipes to a specific rotational direction by the plate springs. In addition, the connecting device 30 may be manufactured more compactly, because the compact spring member which is minimized in a length can be applied and it is unnecessary to mount a bolt. As apparent from the above description, the present invention provides an exhaust pipe connecting device that prevents the separation of the exhaust pipes in a high vibration load state and the generation of contact noise of the flanges that does not require the installation of an additional vibration damping element, i.e., the exhaust pipe connecting device according to the present invention simultaneously blocks vibration and restricts excessive movement of the connecting portion of the exhaust pipes. The present invention is useful for exhaust pipe connecting devices, especially, for all exhaust pipe connecting device mounted on an exhaust passage that extends from an internal combustion engine of a vehicle.

While the invention has been shown and described with respect to the example embodiments, it will be understood by those skilled in the art that various changes and modification may be made without departing from the spirit and scope of the invention as defined in the following claims.

What is claimed is:

1. An exhaust pipe connecting device comprising:
a seal member, mounted on an end portion of a first exhaust pipe;
a coupling member, mounted on an end portion of a second exhaust pipe; and
a spring member, provided between the first exhaust pipe and the second exhaust pipe, that presses the seal member toward the coupling member,
wherein the first exhaust pipe and the second exhaust pipe are rotatably connected to each other when the coupling member contacts the seal member, and the spring member has nonlinear spring characteristics such that a spring constant in a high load region in the operational range of the spring member is larger than the spring constant in a low load region in the operational range of the spring member.

2. The exhaust pipe connecting device according to claim 1, wherein the spring member is a plurality of nonlinear springs.

3. The exhaust pipe connecting device according to claim 2, wherein the plurality of nonlinear springs are arranged parallel with each other and equidistant around the circumference of an end portion of the first exhaust pipe or an end portion of the second exhaust pipe.

4. The exhaust pipe connecting device according to claim 2, wherein each nonlinear spring is a metallic compression spring.

5. The exhaust pipe connecting device according to claim 4, wherein one of the plurality of nonlinear springs operates in the range from the low load region to the high load region, wherein a first nonlinear spring of the plurality of nonlinear springs is compressed when the first exhaust pipe and the second exhaust pipe rock relatively from an initially connected state, and
wherein a second nonlinear spring of the plurality of nonlinear springs operates in only the low load region, wherein the second nonlinear spring is extended when the first exhaust pipe and the second exhaust pipe rock relatively from an initially connected state.

6. The exhaust pipe connecting device according to claim 4, wherein if a relative rocking angle of the first exhaust pipe and the second exhaust pipe is a predetermined value or less, all of the plural nonlinear springs operate in the low load region in which the spring constant is small, and
wherein, if the relative rocking angle of the first exhaust pipe and the second exhaust pipe is more than the predetermined value, one of the plural nonlinear springs operates in the high load region in which the spring constant is large, and further wherein the first nonlinear spring is compressed when the first exhaust pipe and the second exhaust pipe rock relatively from an initially connected state.

7. The exhaust pipe connecting device according to claim 4, wherein the compression spring is a cylindrical coil spring that has a non-uniform pitch.

8. The exhaust pipe connecting device according to claim 4, wherein the compression spring is a conical coil spring that has a uniform pitch angle.

9. The exhaust pipe connecting device according to claim 2, wherein each of the nonlinear springs is a plate spring.

10. The exhaust pipe connecting device according to claim 7, wherein the coil spring is a dual pitch spring.

11. The exhaust pipe connecting device according to claim 2, wherein each of the nonlinear springs has a non-uniform pitch such that a pitch of both end portions is different from a pitch of a middle portion.

12. The exhaust pipe connecting device according to claim 2, wherein a diameter of both end portions for each of the nonlinear springs is different from the diameter of a middle portion.

13. The exhaust pipe connecting device according to claim 2, wherein each of the nonlinear springs is a compression spring which is made partially or entirely of a heat resistant viscoelastic material.

14. The exhaust pipe connecting device according to claim 9, wherein the plate spring is a U-shaped plate spring.

15. The exhaust pipe connecting device according to claim 14, wherein a contact portion of the coupling member with the U-shaped plate spring is formed in a curved shape which changes corresponding to deflection of the plate spring.

16. The exhaust pipe connecting device according to claim 9, wherein the plate spring has a width or a thickness of a middle portion of the plate spring is different from the width or thickness of both end portions of the plate spring.

17. The exhaust pipe connecting device according to claim 9, wherein the plate spring is provided with a notch which is formed at a predetermined position in a plate of the plate spring.

18. The exhaust pipe connecting device according to claim 9, wherein the plate spring includes a plurality of overlapping plates.

19. The exhaust pipe connecting device according to claim 9, wherein the plate spring is configured such that a position of a contact portion with the coupling member can move.

20. The exhaust pipe connecting device according to claim 1, wherein the spring constant in the high load region is at least double the spring constant in the low load region.
